(19) United States
(12) Patent Application Publication
(10) Pub. No.: US 2014/0375798 A1
(43) Pub. Date: Dec. 25, 2014

(54) IMAGING APPARATUS AND IMAGING METHOD FOR IMAGING TARGET SUBJECT AND STORAGE MEDIUM

(71) Applicant: CASIO COMPUTER CO., LTD., Tokyo (JP)

(72) Inventor: Ken Fujita, Tokyo (JP)

(73) Assignee: CASIO COMPUTER CO., LTD., Tokyo (JP)

(21) Appl. No.: 14/276,326

(22) Filed: May 13, 2014

(30) Foreign Application Priority Data
Jun. 20, 2013 (JP) 2013-129504

(51) Int. Cl. G01B 11/14

(52) U.S. Cl. CPC G01B 11/14
USPC 348/140

(57) ABSTRACT

In the present invention, with a preset subject distance (the distance to a photographic subject) being stored in a storage section, a control section constituting a digital camera (imaging apparatus) specifies an imaging target subject, detects the distance to this specified subject, and performs imaging (for example, consecutive photographing or moving image capturing) by an imaging section when the detected distance is substantially equal to the preset subject distance.

### CROSS-REFERENCE TO RELATED APPLICATION

This application is based upon and claims the benefit of priority from the prior Japanese Patent Application No. 2013-129504, filed Jun. 20, 2013, the entire contents of which are incorporated herein by reference.

### BACKGROUND OF THE INVENTION

1. Field of the Invention

The present invention relates to an imaging apparatus and an imaging method capable of detecting a distance to a photographic subject, and a storage medium.

2. Description of the Related Art

An imaging technique called pre-focusing imaging is known in which, in order to take a picture of a subject coming toward an imaging apparatus such as a digital still camera or a video camera, an arbitrary area is focused in advance, and a shutter operation is performed when the subject comes to that area. As a technology using this pre-focusing imaging, a technology disclosed in Japanese Patent Application Laid-Open (Kokai) Publication No. 2007-258862 is known in which a monitoring area is provided in an imaging area of an image sensor and, when an image change is detected in this monitoring area, imaging is performed with a focusing position (focal position) set (fixed) in advance.

### SUMMARY OF THE INVENTION

In accordance with one aspect of the present invention, there is provided an imaging apparatus comprising: a storage section which stores a preset subject distance; a subject specifying section which specifies an arbitrary subject to be an imaging target; a subject distance detecting section which detects a distance to the subject to be an imaging target specified by the subject specifying section; and an imaging control section which performs imaging when the distance to the subject to be an imaging target detected by the subject distance detecting section is substantially equal to the preset subject distance.

In accordance with another aspect of the present invention, there is provided an imaging method for an imaging apparatus in which a preset subject distance has been stored, comprising: a subject specifying step of specifying an arbitrary subject to be an imaging target; a subject distance detecting step of detecting a distance to the subject to be an imaging target specified in the subject specifying step; and an imaging control step of performing imaging when the distance to the subject to be an imaging target detected in the subject distance detecting step is substantially equal to the preset subject distance.

In accordance with another aspect of the present invention, there is provided a non-transitory computer-readable medium having stored thereon a program that is executable by a computer, the program being executable by the computer to perform functions comprising: a storage function for storing a preset subject distance; a subject specifying function for specifying an arbitrary subject to be an imaging target; a subject distance detection function for detecting a distance to the subject to be an imaging target specified by the subject specifying function; and an imaging control function for performing imaging when the distance to the subject to be an imaging target detected by the subject distance detection function is substantially equal to the preset subject distance.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram depicting basic components of a digital camera (imaging apparatus);

FIG. 2 is a diagram for describing imaging timing when a target subject (imaging target) is imaged at a predetermined subject distance;

FIG. 3 is a flowchart of operation when consecutive photographing of a target subject is performed at a predetermined subject distance by using an AF (Automatic Focus) tracking function;

FIG. 4 is a diagram depicting a modification example of the first embodiment in which one distance range is divided into a plurality of ranges in a far-near direction and imaging is performed with a different condition for each of these divisional ranges;

FIG. 5 is a diagram depicting another modification example of the first embodiment, in which a flowchart of operation when moving-image photographing of a target subject is performed at a predetermined subject distance by an AF tracking function is shown;

FIG. 6 is a flowchart of operation when consecutive photographing of a target subject is performed at a predetermined subject distance by a face recognition function in a second embodiment; and

FIG. 7 is a diagram depicting a modification example of the second embodiment, in which a flowchart of operation when consecutive photographing of a target subject is performed at a predetermined subject distance by a face recognition function is shown.

### DETAILED DESCRIPTION OF THE PREFERRED EMBODIMENTS

Hereinafter, embodiments of the present invention are described in detail with reference to the drawings.

### First Embodiment

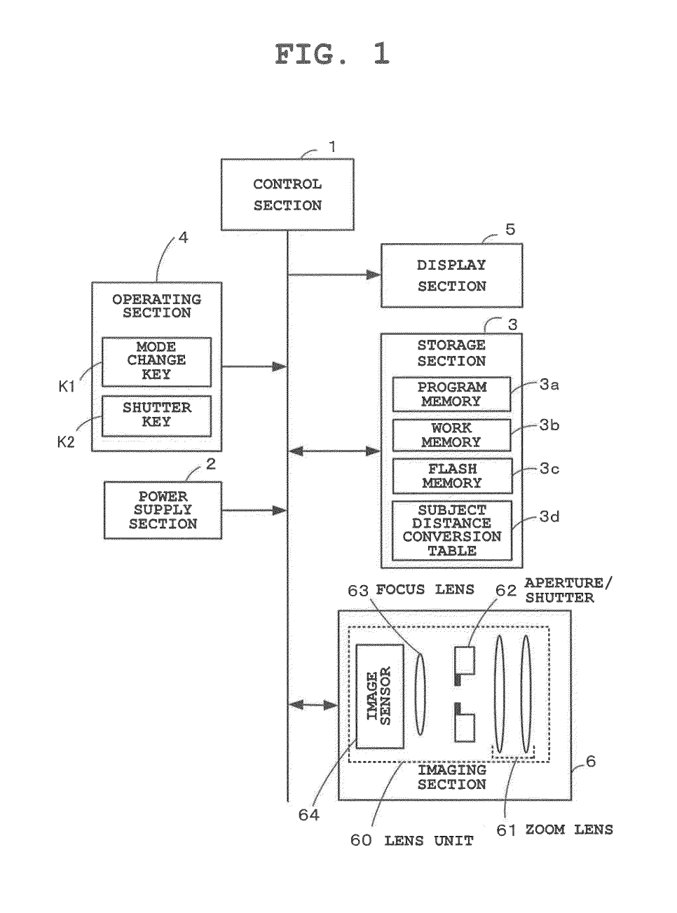

First, a first embodiment of the present invention is described with reference to FIG. 1 to FIG. 3.

FIG. 1 is a block diagram depicting basic components of a digital camera (imaging apparatus).

This digital camera is a digital compact camera capable of taking still images as well as moving images, and has basic functions such as an imaging function, a timing function, and a zoom function. Also, this digital camera has an AF tracking function for continuously focusing on a subject moving toward the digital camera (for example, a marathon runner), as one feature of the imaging function.

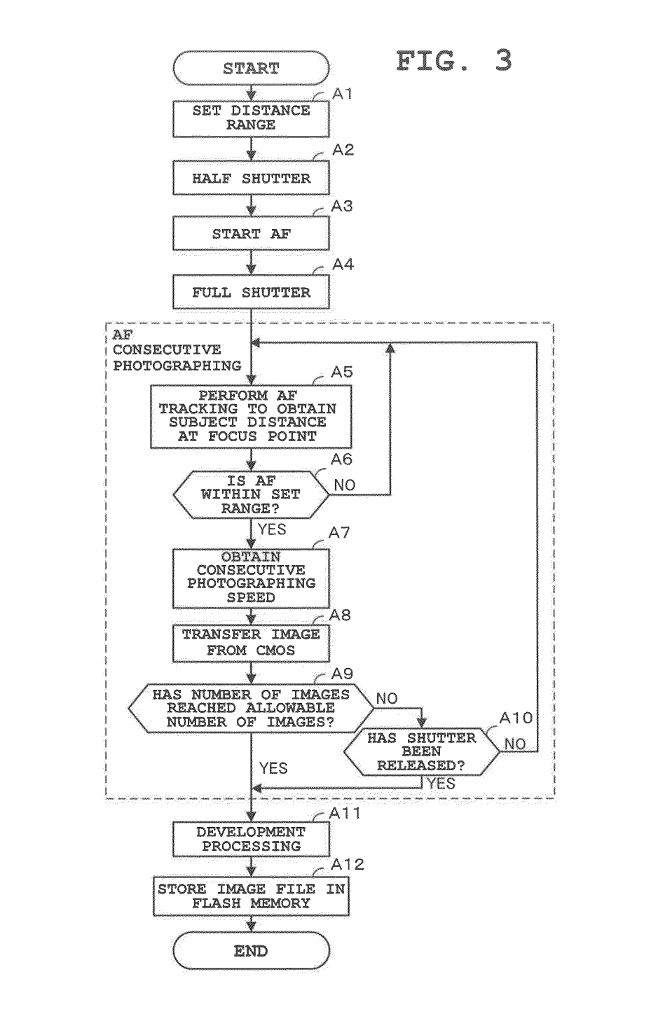

A control section 1 in FIG. 1 operates by electric power supplied from a power supply section (a secondary battery) 2, and controls the overall operation of the digital camera in accordance with various programs stored in a storage section 3. This control section 1 is provided with a CPU (Central Processing Unit) and a memory not shown. The storage section 3 is structured to include a ROM (Read Only Memory) and a flash memory, and has a program memory 3a which stores programs and various applications to achieve the present embodiment according to the operational procedures shown in FIG. 3 described below, a work memory 3b which temporarily stores various information (for example, flags) required to operate the digital camera, a flash memory 3c for storing captured images, and a subject distance conversion table 3d described below. Note that the storage section 3 may be structured to include a detachable portable memory (recording media) such as an SD (Secure Digital) card or an ID (Integrated Circuit) card. Although not illustrated, in a case where the storage section 3 is connected to a network by a communication function, the storage section 3 may include a storage area on the side of a predetermined server apparatus.

An operating section 4 in FIG. 1 includes press-button type various keys, such as a mode change key K1 for switching between an imaging mode and a replay mode, a two-step press-type (half-press and full-press) shutter key K2 for instructing to start imaging, and a setting key not shown that is used to set an imaging condition such as a shutter speed, an aperture value, exposure, etc. The control section 1 performs processing in accordance with an input operation signal outputted by an operation key from the operating section 4. A display section 5 in FIG. 1 is a high-definition liquid-crystal display or an organic EL (Electro Luminescence) display, which serves as a monitor screen (live view screen) for displaying an image to be captured (live view image) and a replay screen for replaying a captured image.

An imaging section 6 in FIG. 1 is structured to have a lens unit 60, and includes various sensors, an analog processing section, and a digital processing section omitted in the drawing. This imaging section 6, which is capable of capturing still images and moving images, performs color separation, gain adjustment for each RGB (Red Green Blue) color component, and the like on photoelectrically converted image signals (analog value signals), and after converting the image signals to digital value data, performs color interpolation processing (de-mosaic processing) on the digitalized image data, and displays the image data in full-color on the display section 5. The lens unit 60 has a zoom lens 61, an aperture/shutter 62, a focus lens 63, and an image sensor (such as a CCD (Charge-Coupled Device) or a CMOS (Complementary Metal-Oxide Semiconductor)) 64.

By driving the zoom lens 61, the aperture/shutter 62, and the focus lens 63 in response to a control signal from the control section 1, the imaging section 6 controls zoom adjustment, focus adjustment, exposure adjustment, and the start/end of imaging, and performs optical zoom processing, focus processing, aperture adjustment processing, white balance adjustment processing, etc. Here, the imaging section 6 drives the mechanisms of the zoom lens 61, the aperture/shutter 62, and the focus lens 63 serving as optical system components for imaging in accordance with their imaging parameters (a zoom value, a focus value, and an aperture value), and thereby performs optical zoom processing, automatic focus adjustment (AF) processing, aperture adjustment processing, etc. For this AF processing, a contrast detection method is adopted in which a peak value of a contrast value is calculated based on a component of a frequency band extracted from a signal of a captured image, and taken as a focal position. However, a phase difference detection method may be adopted.

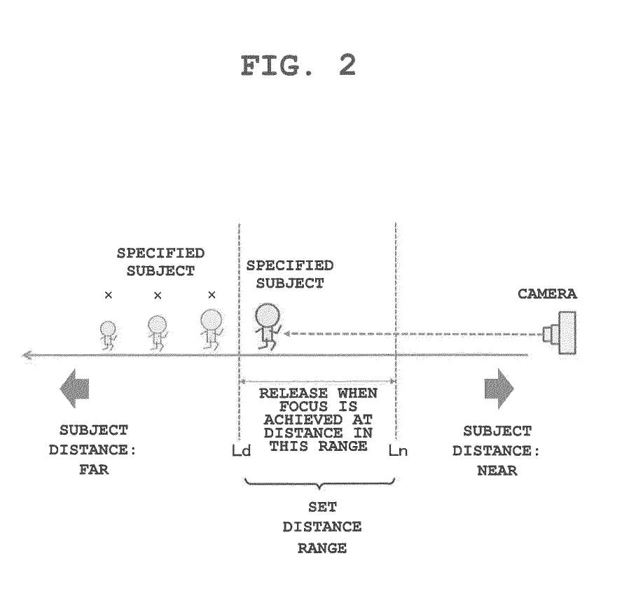

FIG. 2 is a diagram for describing imaging timing when a target subject (imaging target) is imaged at a predetermined subject distance.

In the first embodiment, in a state where a subject (marathon runner) moving toward the digital camera (imaging apparatus) is an imaging target and the digital camera is focusing on the position of this subject, when the AF tracking function is started, the digital camera performs AF tracking while focusing on the subject. Then, when the subject comes within a range of a predetermined subject distance set in advance, imaging (consecutive imaging) is automatically started. Note that the target (imaging target) subject herein is a specified subject which has been specified as an AF tracking target by a half-press operation of the shutter key K2 or the like by the photographer (user) and on the position of which the digital camera has been focusing. Also, the predetermined subject distance herein is a focal distance from an arbitrary position of the focus lens 63 set by a user operation to the specified target (imaging target) subject.

In the drawing, a range from Ld to Ln represents the range of a predetermined subject distance temporarily stored in the work memory 3b. This range is a distance range with distance differences, that is, a distance range from a far distance Ld to a near distance Ln with respect to the zoom lens 61. That is, in the first embodiment, auto release is performed (a consecutive photographing operation is started) when the distance from the zoom lens 61 to a specified subject is within the set distance range Ld to Ln. When the distance is out of the set distance range Ld to Ln, longer than the distance Ld, or shorter than the distance Ln, this consecutive photographing operation is not performed.

In this embodiment, every time the position of the focus lens 63 for adjusting the focal position is changed by the AF tracking function, the control section 1 refers to the subject distance conversion table 3d based on the position of the focus lens 63 so as to obtain a distance to a specified subject, and judges whether the distance is within the set distance range Ld to Ln. The subject distance conversion table 3d is configured to store a focal subject distance corresponding to the position of the focus lens 63. Depending on the AF accuracy, a subject distance in units of 30 cm or 20 cm can be obtained. Also, regarding the consecutive photographing speed, for example, “10 fps” or “5 fps” is set.

As such, the imaging apparatus (digital camera) of the first embodiment is structured to include a storage section (the control section 1 and the work memory 3b) which stores a predetermined preset subject distance, a subject specifying section (the imaging section 6) which specifies an arbitrary predetermined subject (moving subject) as an imaging target, a subject distance detecting section (the control section 1, the subject distance conversion table 3d, and the imaging section 6) which detects a distance to the predetermined subject specified by the subject specifying section, and an imaging control section (the control section 1 and the imaging section 6) which performs imaging when the distance to the predetermined subject detected by the subject distance detecting means is substantially equal to the predetermined subject distance.

Next, the operational concept of the digital camera in the first embodiment is described with reference to a flowchart depicted in FIG. 3. Herein, each function described in the flowchart is stored in readable program code format and operations based on these program codes are sequentially performed. Also, operations based on the above-described program codes transmitted over a transmission medium such as a network can also be sequentially performed. That is, the unique operations of the present embodiment can be performed using programs and data supplied from an outside source over a transmission medium, in addition to a recording medium. This applies to other embodiments described later. FIG. 3 is a flowchart outlining the operation of a characteristic portion of the present embodiment, from among all of the operations of the digital camera. After exiting the flow in FIG. 3, the process is returned to the main flow (not shown) of the entire operations.

FIG. 3 is a flowchart of operation when consecutive photographing of a target subject is performed at a predetermined subject distance by using an AF tracking function. In the drawing, an area surrounded by a broken line indicates operations for AF consecutive photographing.

First, before starting consecutive photographing, the control section 1 performs processing for setting the range of a predetermined subject distance (Step A1). For example, the photographer operates a numerical value key (omitted in the drawing) of the operating section 4 and thereby inputs desired subject distances Ld and Ln so as to set a distance range in the work memory 3b, or focuses on a dummy subject and thereby sets subject distances Ld and Ln corresponding to a focal position read out from the subject distance conversion table 3d as a distance range in the work memory 3b.

When the shutter key K2 is half pressed (subjected to a half-shutter operation) with a desired distance range being set as described above (Step A2), the control section 1 starts AF processing (Step A3). Here, in order to specify a desired subject (marathon runner) as an imaging target, the photographer focuses on the subject to be specified, and then fully presses the shutter key K2 (performs a full-shutter operation) (Step A4). As a result, the focal position is changed as AF tracking follows the specified subject. Based on the position of the focus lens 63 at that time, the control section 1 refers to the subject distance conversion table 3d and obtains a distance to the specified subject (Step A5). Then, the control section 1 judges whether the distance to the specified subject is within the distance range set in the work memory 3b (Step A6).

Here, when the distance to the specified subject is not within the set distance range (NO at Step A6), the control section 1 returns to Step A5 and enters a standby state while performing the AF tracking. When the distance is within the set distance range (YES at Step A6), the control section 1 obtains a consecutive photographing speed set in advance (Step A7), receives an image (live view image) transferred from the image sensor (CMOS) of the imaging section 6, and temporarily stores the image in the work memory 3b (Step A8). Then, the control section 1 judges whether the number of images temporarily stored in the work memory 3b has reached an allowable number of images set in advance (for example, thirty) (Step A9), and judges whether the full-press (full-shutter) operation on the shutter key K2 has been released (Step A10).

Here, when judged that the number of images has not reached the allowable number of images (NO at Step A9) and the shutter key K2 is being continuously operated (NO at Step A10), the control section 1 returns to Step A5 and, on condition that the distance is within the distance range (Step A6), performs a consecutive photographing operation (Steps A7 and A8). Then, when the number of images reaches the allowable number of images (YES at Step A9) or the full-press (full-shutter) operation on the shutter key K2 is released (YES at Step A10), the control section 1 reads out each captured image temporarily stored in the work memory 3b and performs development processing regarding color conversion, white balance, sharpness, and the like (Step A11). Then, the control section 1 performs processing for converting the image after development to a standard file format and recording and storing the converted image in the flash memory 3c for image storage (Step A12), and then exits the flow of FIG. 3.

As described above, in the first embodiment, the control section 1 detects a distance to a specified predetermined subject and, when the detected distance becomes substantially equal to a predetermined subject distance set in advance, performs imaging by the imaging section 6. Therefore, only by a target subject being specified and a predetermined subject distance being set, the target subject can be imaged at a desired distance, by which a desired captured image can be easily obtained. In this case, even if the position of the subject is shifted, that is, even if the subject is shifted in a direction substantially orthogonal to the optical axial direction of the camera, the subject can be imaged as long as the subject distance is the same.

The predetermined subject herein is a moving subject, and the control section 1 detects a distance to this moving subject while tracking it. By this configuration, in the present embodiment, a target subject can be imaged with a desired size and composition even if it is a moving subject.

Also, the predetermined subject distance herein is a distance range with distance differences, and the control section 1 performs consecutive imaging when the distance to the moving subject is within the set distance range. By this configuration, in the present embodiment, not only imaging at a desired distance (one point) but also imaging near the desired distance can be performed.

Moreover, the consecutive imaging herein is consecutive photographing, and a plurality of consecutively photographed images can be obtained according to the consecutive photographing speed. By this configuration, in the present embodiment, not only an image captured at a desired one point but also images captured nearby can be obtained.

Furthermore, the control section 1 detects a distance to the predetermined subject based on the focal position of the AF tracking function. By this configuration, in the present embodiment, a subject distance can be appropriately detected by the existing technology called AF tracking.

Still further, the predetermined subject specified herein is a subject being tracked by the AF tracking function. By this configuration, in the present embodiment, a photographic subject can be reliably specified at the start of AF tracking without a special operation for specifying this subject.

In the above-described first embodiment, one set distance range is set. However, a plurality of distance ranges may be set. In this case, the plurality of distance ranges may be set such that they are spaced apart from each other, or one distance range may be divided into a plurality of ranges in a far-near distance.

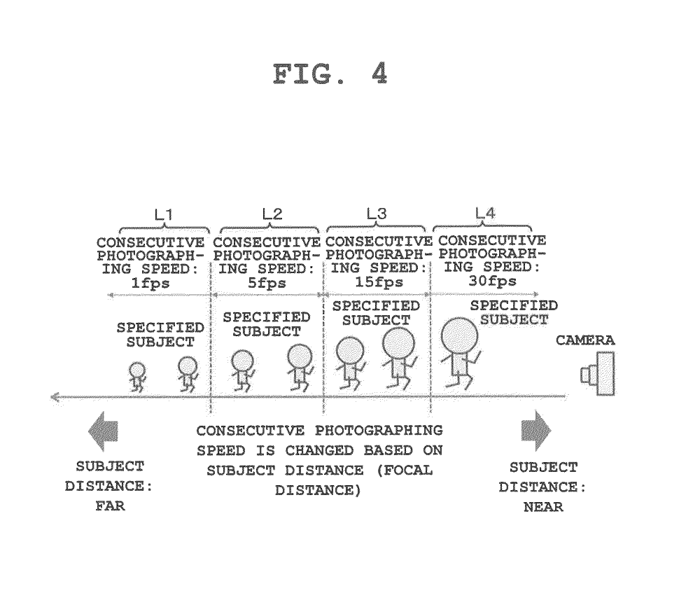

FIG. 4 is a diagram depicting a modification example of the first embodiment in which one distance range has been divided into a plurality of ranges in a far-near direction and a different condition has been set for each of these divisional ranges. That is, one distance range has been divided into four ranges, and different consecutive photographing speeds have been set as imaging conditions in association with the divisional ranges L1, L2, L3, and L4. In the example, a consecutive photographing speed in the divisional range L1 has been set at “1 fps”, a consecutive photographing speed in the divisional range L2 has been set at “5 fps”, a consecutive photographing speed in the divisional range L3 has been set at “15 fps”, and a consecutive photographing speed in the divisional range L4 has been set at “30 fps”.

As such, by the distance range being divided into a plurality of ranges in a far-near direction and a different imaging condition being set for each of these divisional ranges for imaging, an image captured with a different imaging condition can be obtained for each divisional range.

In this case, by a different consecutive photographing speed being set as an imaging condition for each divisional range, the consecutive photographing speed can be increased in a divisional range with a high degree of importance, and can be decreased in a divisional range with a low degree of importance.

As this imaging condition to be set for each divisional range, not only the consecutive photographing speed but also the image size or image quality may be used. By the image size or image quality being used as a photographing condition, the image size or image quality can be increased in a divisional range closer to the camera.

In the above-described first embodiment, still images are obtained by a consecutive photographing operation. However, the present invention can be similarly applied in the case of moving image capturing.

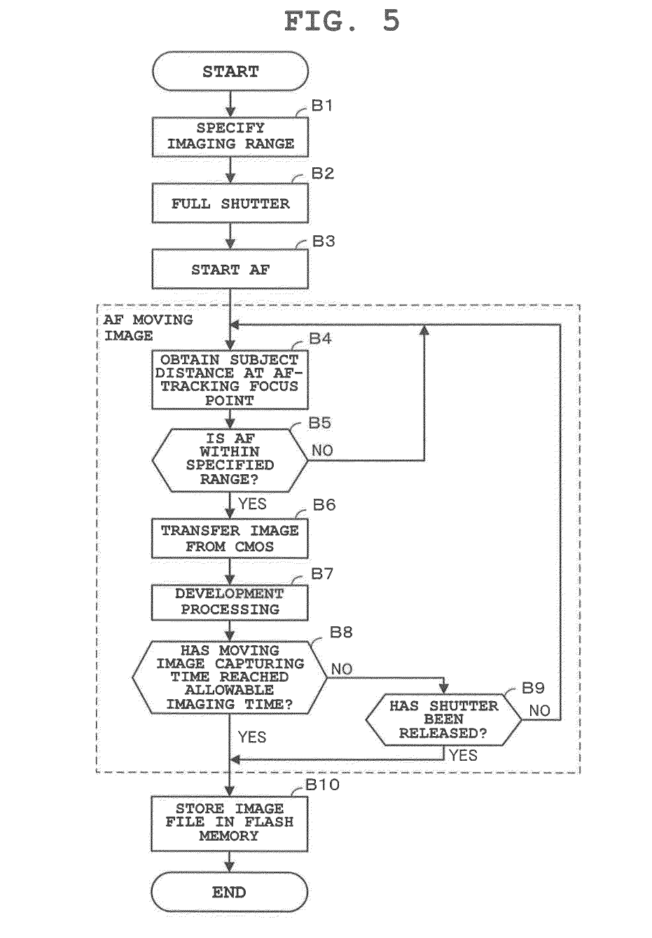

FIG. 5 is a flowchart basically similar to the flow of FIG. 3, depicting operation when moving image capturing of a target subject is performed at a predetermined subject distance by using an AF tracking function, as another modification example of the first embodiment. An area surrounded by a broken line in the drawing indicates operations for AF moving image capturing. Note that, in FIG. 5, portions basically similar to the flow of FIG. 3 will be briefly described.

First, before starting moving image capturing, the control section 1 performs processing for setting the range of a predetermined subject distance (Step B1). Here, in order to specify a desired subject (marathon runner) as an imaging target, the photographer focuses on the subject to be specified. In this state, when the shutter key K2 is fully pressed (is subjected to a full shutter operation) (Step B2), the control section 1 starts AF processing (Step B3). Then, with reference to the subject distance conversion table 3d based on the position (focal position) of the focus lens 63 performing AF tracking of the specified subject, the control section 1 obtains a subject distance (a distance to the specified subject) corresponding to the focal position of the focus lens 63 (Step B4). Subsequently, the control section 1 judges whether the distance to the specified subject is within the distance range set in the work memory 3b (Step B5).

Here, when the distance to the specified subject is not within the set distance range (NO at Step B5), the control section 1 returns to Step B4 described above and enters a standby state while performing the AF tracking. When the distance is within the set distance range (YES at Step B5), the control section 1 receives a moving image (live view image) transferred from the image sensor (CMOS) of the imaging section 6 and temporarily stores the image in the work memory 3b (Step B6). Then, after performing development processing on the moving image temporarily stored in the work memory 3b (Step B7), the control section 1 judges whether the moving image capturing time has reached an allowable imaging time set in advance (for example, three minutes) (Step B8), and judges whether the full-press (full-shutter) operation on the shutter key K2 has been released (Step B9).

Here, when judged that the moving image capturing time has not reached the allowable imaging time (NO at Step B8) and the shutter key K2 is being continuously operated (NO at Step B9), the control section 1 returns to Step B4 and, on condition that the distance is within the distance range (Step B5), performs moving image capturing (Steps B6 and B7). Then, when the moving image capturing time reaches the allowable imaging time (YES at Step B8) or the full-press (full-shutter) operation on the shutter key K2 is released (YES at Step B9), the control section 1 performs processing for converting the moving image temporarily stored in the work memory 3b to a standard file format and recording and storing the converted moving image in the flash memory 3c for storing captured images (Step B10), and exists the flow of FIG. 5.

As described above, in this configuration as well where moving image capturing of a target subject is performed at a predetermined subject distance by using the AF tracking function, a target subject can be appropriately captured at a predetermined subject distance, as in the case of the consecutive photographing in the first embodiment. That is, only by a target subject being specified and a predetermined subject distance being set, moving image capturing of the target subject can be performed at a desired distance, by which desired captured images can be easily obtained.

### Second Embodiment

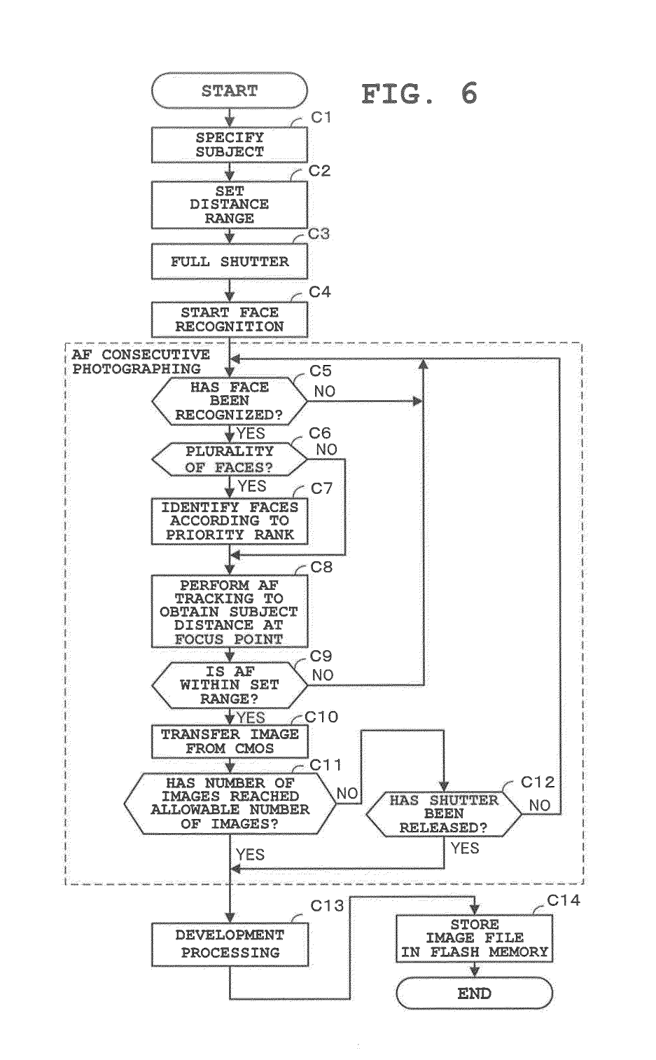

A second embodiment of the present invention is described below with reference to FIG. 6.

In the above-described first embodiment, a subject being tracked by the AF tracking function is taken as a specified subject. However, in the second embodiment, a person recognized as a photographic subject by analyzing a live view image is specified as a predetermined subject. By this subject recognition, a plurality of subjects can be specified. Note that sections that are basically the same or have the same name in both embodiments are given the same reference numerals, and therefore explanations thereof are omitted. Hereafter, the characteristic portions of the second embodiment will mainly be described. A digital camera of the second embodiment has a subject recognition function (face recognition function) for analyzing a live view image and recognizing a photographic subject (person) in this image. Note that the face recognition function in the present embodiment is a technology generally used in cameras. Since it is a known technology, specific explanation thereof is omitted.

FIG. 6 is a flowchart of operation when consecutive photographing of a target subject is performed at a predetermined subject distance by using a face recognition function in the second embodiment. An area surrounded by a broken line in the drawing indicates operations for AF consecutive photographing.

First, before starting consecutive photographing, the control section 1 performs processing for specifying a predetermined subject (Step C1). In this case, when the predetermined subject is a person, the predetermined subject (person) is specified by processing of registering, as reference information for person recognition, a face image and its characteristic information that serve as a reference at the time of person recognition. Also, in a case where a plurality of persons are specified as predetermined subjects, reference information for person recognition is registered for each person. When the plurality of persons are registered, priority ranks indicating the order of photographing are also registered in association with the respective persons.

Next, as with Step A1 of FIG. 3, the control section 1 performs processing for setting the range of a predetermined subject distance (Step C2). In this state, when the shutter key K2 is fully pressed (is subjected to a full shutter operation) (Step C2), the control section 1 starts face recognition processing for recognizing the face of a person by analyzing a moving image (live view image) transferred from the image sensor (CMOS) of the imaging section 6 (Step C4). Then, with reference to the reference information for person recognition (the face image and characteristic information of the registered person), the control section 1 judges whether the face of the specified subject has been successfully recognized, that is, whether the registered person is present in the image, and enters and remains in a standby state until the face of the specified subject is recognized (Step C5).

When any specified subject (the face of the person) is successfully recognized (YES at Step C5), the control section 1 judges whether a plurality of faces have been recognized (whether the faces of a plurality of registered persons have appeared in the image) (Step C6). When judged that not a plurality of faces but one face has been recognized (NO at Step C6), the control section 1 performs AF tracking by focusing on the face of the person (Step C8). On the other hand, when judged that the faces of a plurality of persons have been recognized (YES at Step C6), the control section 1 sequentially identifies the persons one by one according to the priority rank of each person registered in advance (Step C7), and performs AF tacking by focusing on the face of this identified person (Step C8). Here, if the identified face has already been included in the plurality of recognized faces, the faces of other persons excluding that face are identified according to the priority rank.

Then, the control section 1 refers to the subject distance conversion table 3d while performing the AF tracking of the specified subject (the face of the specified person), reads out the subject distance based on the position of the focus lens 63, and judges whether the subject distance (the distance to the specified subject) is within the distance range set in the work memory 3b (Step C9). When the distance to the specified subject is not within the set distance range (NO at Step C9), the control section 1 returns to Step C5 and enters a standby state while performing the face recognition. When the distance is within the set distance range (YES at Step C9), the control section 1 obtains a predetermined consecutive photographing speed, receives an image (live view image) transferred from the image sensor (CMOS), and temporarily stores the image in the work memory 3b (Step C10). Then, the control section 1 judges whether the number of images temporarily stored in the work memory 3b has reached an allowable number of images set in advance (for example, thirty) (Step C11) and judges whether the full-press (full-shutter) operation on the shutter key K2 has been released (Step C12).

Here, when judged that the number of images has not reached the allowable number of images (NO at Step C11) and the shutter key K2 is being continuously operated (NO at Step C12), the control section 1 returns to Step C5 and, on condition that the distance to the specified subject is within the set distance range (Steps C6 to C9), performs a consecutive photographing operation (Step C10). That is, the control section 1 performs a consecutive photographing operation of sequentially photographing each subject (persons) while sequentially focusing thereon. Then, when the number of images reaches the allowable number of images (YES at Step C11) or the full-press (full-shutter) operation on the shutter key K2 is released (YES at Step C12), the control section 1 performs development processing on each of the images temporarily stored in the work memory 3b (Step C13). Then, the control section 1 performs processing for converting the images to a standard file format and recording and storing the converted images in the flash memory 3c for image storage (Step C14), and exits the flow of FIG. 6.

As described above, in the second embodiment, the control section 1 specifies a person recognized by analyzing a live view image as a predetermined subject and, when the distance to this specified subject is substantially equal to a predetermined subject distance set in advance, performs a photographing operation. Therefore, the specified subject can be appropriately photographed at the predetermined subject distance. Also, even if the specified subject is framed out of the photographing range and then framed in, it can be reliably photographed.

Also, when the faces of a plurality of subjects (persons) are recognized in the face recognition processing, the control section 1 performs a consecutive photographing operation of sequentially photographing the subjects while sequentially focusing thereon (focusing on the faces of the persons) in accordance with priority ranks set in advance. As a result of this configuration, consecutive photographing can be performed focusing on each of a plurality of subjects.

In the above-described second embodiment, when the faces of a plurality of subjects (persons) are recognized, a consecutive photographing operation of sequentially photographing the subjects while sequentially focusing on the subjects (the faces of the persons) is performed. However, an image may be acquired in which the focus appears to be on each of a plurality of subjects irrespective of whether the subjects are far or near.

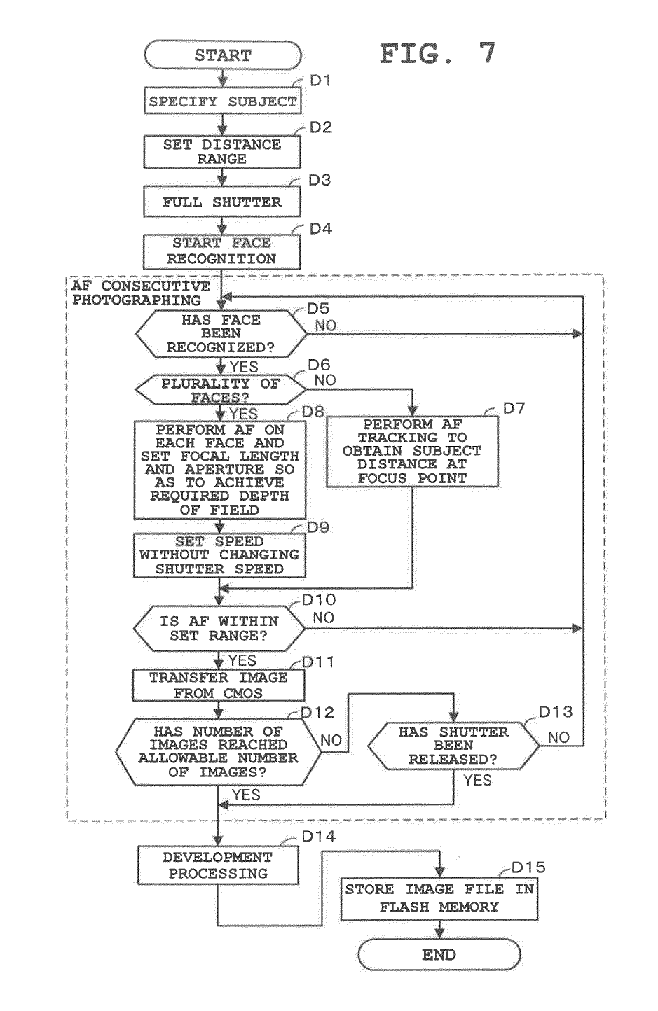

FIG. 7 is a flowchart basically similar to the flow of FIG. 6, depicting operation when consecutive photographing of a target subject is performed at a predetermined subject distance by using an AF tracking function, as a modification example of the second embodiment. An area surrounded by a broken line in the drawing indicates operations for AF consecutive photographing. Note that, in FIG. 7, portions basically similar to the flow of FIG. 6 will be briefly described.

First, before starting consecutive photographing, the control section 1 performs processing for specifying a predetermined subject (Step D1) and processing for setting the range of a predetermined subject distance (Step D2), as with Steps C1 to C6 of FIG. 6. In this state, when a full-press (full-shutter) operation is performed on the shutter key K2 (Step D3), the control section 1 starts face recognition processing for analyzing a moving image (live view image) transferred from the image sensor (CMOS) of the imaging section 6 and recognizing the face of a person (Step D4). Then, until the face of the specified subject is recognized, the control section 1 enters and remains in a standby state while judging whether the face of the specified subject has been successfully recognized (Step D5). Then, when judged that the specified subject (the face of the person) has been successfully recognized (YES at Step D5), the control section 1 judges whether a plurality of faces have been recognized (Step D6). When judged that not a plurality of faces but one face has been recognized (NO at Step D6), the control section 1 focuses on the face of this person and performs AF tracking (Step D7).

At Step D6, when judged that the faces of a plurality of persons have been recognized (YES at Step D6), the control section 1 sequentially focuses on the faces of the persons by AF processing, and sets a focal length and aperture such that a necessary depth of field is achieved based on whether the persons are away from or near each other (Step D8). For example, when the persons are away from each other, the control section 1 increases the aperture value, moves the zoom lens 61 so as to shorten the focal length, and thereby deepens the depth of field to widen the focused range. Conversely, when the persons are near each other, the control section 1 decreases the aperture value, lengthens the focal length, and thereby makes the depth of field shallow so as to narrow the focused range. Next, the control section 1 adjusts brightness by setting a speed (ISO) without changing the shutter speed (Step D9).

Then, as with Steps C9 to C14 of FIG. 3, the control section 1 judges whether the distance to the specified subject (face) is within the distance range set in the work memory 3b (Step D10). When the distance is not within the set distance range (NO at Step D10), the control section 1 returns to Step D5 and enters a standby state while performing the face recognition. When the distance is within the set distance range (YES at Step D10), the control section 1 obtains a consecutive photographing speed set in advance, receives an image (live view image) transferred from the image sensor (CMOS), and temporarily stores the image in the work memory 3b (Step D11). Then, the control section 1 judges whether the number of images stored in the work memory 3b has reached an allowable number of images set in advance (Step D12), and judges whether the full-press (full-shutter) operation on the shutter key K2 has been released (Step D13).

Here, when judged that the number of images has not reached the allowable number of images (NO at Step D12) and the shutter key K2 is being continuously operated (NO at Step D13), the control section 1 returns to Step D5. When judged that the number of images has reached the allowable number of images (YES at Step D12) or the full-press (full-shutter) operation on the shutter key K2 has been released (YES at Step D13), the control section 1 performs development processing on each of the images (Step D14). Then, after performing processing for converting the images to a standard file format and recording and storing the converted images in the flash memory 3c for image storage (Step D15), the control section 1 exits the flow of FIG. 7.

As described above, by the depth of field being controlled when a plurality of specified subjects (the faces thereof) are recognized by face recognition processing, an image can be acquired in which the focus appears to be on each of their faces. As a result of this configuration, a plurality of persons can be photographed simultaneously.

Note that, although the face of a subject (person) is recognized for person identification in the above-described second embodiment, a number card stuck on the back or chest of a marathon runner may be recognized for this person identification.

Also, although a marathon runner has been exemplarily described as a moving subject in the above-described embodiments, the moving subject may be a moving automobile, pet, or child. In addition, the photographic subject to be imaged is not limited to a moving subject, and the present invention can also be applied to a case where the digital camera approaches a standing-still subject.

In the above-described second embodiment, prior to the start of consecutive photographing, processing for setting a predetermined subject and the range of a predetermined subject distance is performed. However, the range of a predetermined subject distance and a predetermined subject may be stored in advance in association with each other. Also, in the case of a plurality of predetermined subjects, a different range of a subject distance may be associated and stored for each subject.

Also, in the above-described second embodiment, a plurality of faces are recognized and, when the distances to the subjects is within a set distance range, a consecutive photographing operation of sequentially photographing the subjects (persons) while sequentially focusing on the subjects is performed. However, consecutive photographing of only the subject with the highest priority rank among the plurality of recognized faces may be performed.

Moreover, in the above-described embodiments, consecutive photographing is performed within a distance range with a width. However, the consecutive photographing may be performed at one focal length. In this case, single imaging may be performed.

Furthermore, in the above-described embodiments, the present invention is applied to a digital compact camera (a digital still camera/video camera) as an imaging apparatus. However, the present invention may be applied to a single-lens reflex camera, a camera-equipped smartphone, a portable information communication apparatus for personal use, a tablet terminal, a game machine, a musical player, or an electronic wristwatch.

Still further, the “apparatuses” or the “sections” in the above-described embodiments are not required to be in a single housing and may be separated into a plurality of housings by function. In addition, the steps in the above-described flowcharts are not required to be processed in time-series, and may be processed in parallel, or individually and independently.

While the present invention has been described with reference to the preferred embodiments, it is intended that the invention be not limited by any of the details of the description therein but includes all the embodiments which fall within the scope of the appended claims.

What is claimed is:

1. An imaging apparatus comprising:
a storage section which stores a preset subject distance;
a subject specifying section which specifies an arbitrary subject to be an imaging target;
a subject distance detecting section which detects a distance to the subject to be an imaging target specified by the subject specifying section; and
an imaging control section which performs imaging when the distance to the subject to be an imaging target detected by the subject distance detecting section is substantially equal to the preset subject distance.

2. The imaging apparatus according to claim 1, wherein the subject to be an imaging target is a moving subject, and
wherein the subject distance detecting section detects a distance to the moving subject while tracking the moving subject.

3. The imaging apparatus according to claim 2, wherein the preset subject distance is a distance range with distance differences, and
wherein the imaging control section performs consecutive imaging when the distance to the moving subject detected by the subject distance detecting section is within the distance range.

4. The imaging apparatus according to claim 3, wherein the consecutive imaging is consecutive photographing or moving image capturing.

5. The imaging apparatus according to claim 3, wherein the distance range is divided into a plurality of divisional ranges in a far-near direction, and
wherein the imaging control section performs imaging with a different imaging condition for each of the divisional ranges when performing the consecutive imaging.

6. The imaging apparatus according to claim 5, wherein the imaging condition is a consecutive photographing speed.

7. The imaging apparatus according to claim 5, wherein the imaging condition is an image size or an image quality.

8. The imaging apparatus according to claim 2, further comprising:
a focus adjusting section which adjusts a focus by moving a focus lens while tracking the moving subject,
wherein the subject distance detecting section detects a distance to the moving subject based on the focus adjusted by the focus adjusting section.

9. The imaging apparatus according to claim 8, wherein the subject specifying section specifies a subject being tracked by the focus adjusting section as the subject to be an imaging target.

10. The imaging apparatus according to claim 1, wherein the subject specifying section specifies a subject to be an imaging target by performing subject recognition processing by analyzing a subject in a live view image.

11. The imaging apparatus according to claim 10, wherein the imaging control section, when a plurality of subjects are specified in the subject recognition processing by the subject specifying section, sequentially images the plurality of subjects according to priority ranks set in advance.

12. The imaging apparatus according to claim 10, wherein the imaging control section, when a plurality of subjects are specified in the subject recognition processing by the subject specifying section, controls a depth of field so as to focus on the plurality of subjects.

13. The imaging apparatus according to claim 10, further comprising:
a setting section which sets the preset subject distance in association with the subject to be an imaging target specified by the subject specifying section,
wherein the imaging control section performs imaging when the distance to the subject to be an imaging target detected by the subject distance control section is substantially equal to the preset subject distance set in association with the subject to be an imaging target by the setting section.

14. An imaging method for an imaging apparatus in which a preset subject distance has been stored, comprising:
a subject specifying step of specifying an arbitrary subject to be an imaging target;
a subject distance detecting step of detecting a distance to the subject to be an imaging target specified in the subject specifying step; and
an imaging control step of performing imaging when the distance to the subject to be an imaging target detected in the subject distance detecting step is substantially equal to the preset subject distance.

15. A non-transitory computer-readable medium having stored thereon a program that is executable by a computer, the program being executable by the computer to perform functions comprising:
a storage function for storing a preset subject distance;
a subject specifying function for specifying an arbitrary subject to be an imaging target;
a subject distance detection function for detecting a distance to the subject to be an imaging target specified by the subject specifying function; and
an imaging control function for performing imaging when the distance to the subject to be an imaging target detected by the subject distance detection function is substantially equal to the preset subject distance.
